(19) United States
(12) Patent Application Publication
(10) Pub. No.: US 2015/0180088 A1
(43) Pub. Date: Jun. 25, 2015

(54) ELECTROCHEMICAL LEAD BATTERY INCLUDING A SPECIFIC ADDITIVE

(71) Applicants: COMMISSARIAT A L'ENERGIE ATOMIQUE ET AUX ENERGIES ALTERNATIVES, Paris (FR); INSTITUTE POLYTECHNIQUE DE GRENOBLE, Grenoble Cedex 1 (FR)

(72) Inventors: Alexandre Oury, Chambery (FR); Yann Bultel, Voreppe (FR); Angel Zhivkov Kirchev, Aix les Bains (FR)

(21) Appl. No.: 14/416,037

(22) PCT Filed: Jul. 18, 2013
(86) PCT No.: PCT/EP2013/065151

§ 371 Date: Jan. 20, 2015

(30) Foreign Application Priority Data
Jul. 20, 2012 (FR) 1257084

(51) Int. Cl. H01M 10/08

(52) U.S. Cl. CPC H01M 10/08

(57) ABSTRACT

The present invention relates to an electrochemical lead battery comprising at least one electrochemical cell comprising a positive electrode comprising lead oxide PbO₂ and a negative electrode comprising lead metal separated by an electrolyte comprising methanesulfonic acid and at least one lead salt, characterized in that said electrolyte further comprises fluoride ions.

### TECHNICAL FIELD

The present invention relates to an electrochemical lead battery comprising, in its electrolyte, a specific additive intended, inter alia, to improve the strength of the lead dioxide present at the surface of the positive electrode.

The present invention may find application in all the fields requiring storage of electric energy, with view to giving it back for subsequent use, such as for example the field for stationary storage of electricity.

### STATE OF THE PRIOR ART

Traditional electrochemical lead batteries comprise a set of unit cells mounted in series each comprising a pair of electrodes, a positive electrode and a negative electrode respectively, said electrodes are isolated from one another by a porous separator comprising an electrolyte.

The aforementioned electrodes are conventionally formed with a grid in a lead alloy, the cavities of which are filled with a porous paste:
lead oxide PbO₂ for the positive electrode; and
lead metal Pb for the negative electrode,

while the electrolyte consists in a diluted solution of sulfuric acid.

In conventional lead batteries, a small fraction of the lead is used for storing current (about 30%) and the structure of the electrodes is led to degradation, after a certain lifetime of the accumulator, this makes it unusable in the long term.

In order to circumvent these drawbacks, certain authors such as Hazza et al., Phys. Chem. Chem. Phys., 6 (2004), 1773, have proposed a novel technology of electrochemical lead battery based on the circulation of a specific electrolyte: a solution of methanesulfonic acid CH₃SO₃H (symbolized, conventionally, by the acronym MSA) comprising, as a lead salt, lead methanesulfonate Pb(CH₃SO₃)₂. This type of technology is illustrated in FIG. 1, enclosed as an appendix, which illustrates a battery cell 1 comprising a negative electrode 3 (covered on one face with a layer of lead metal 4) and a positive electrode 5 (covered on one face with a PbO₂ layer 6) positioned on either side of an electrolyte 7 as defined above, this electrolyte being connected, via conduits 9 and 11, to a reservoir 13 comprising this electrolyte giving the possibility of supplying via a pump 15 the electrodes with electrolyte. The electrodes 3 and 5 are as for them connected to an outer electric circuit 17, which is fed with the electrons generated during electrochemical reactions occurring at the electrodes.

From an operating point of view, during the charging process, the ions Pb²⁺ are oxidized so as to form a deposit of lead dioxide (PbO₂) on the positive electrode and reduced in order to form a deposit of lead metal on the negative electrode. During the discharge process, these deposits are re-dissolved as ions Pb²⁺ in the electrolyte.

These processes may be summarized by the following equations:
*at the positive electrode:

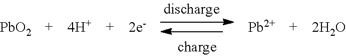

*at the negative electrode:

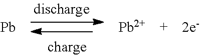

the overall reaction for operating the battery thus being the following:

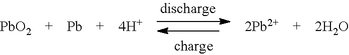

The advantage of this type of battery is the great solubility of lead salts in MSA (the latter may range up to 2 M), which allows storage of a large amount of Pb (II) in the soluble state. Furthermore, this type of battery does not require the use of a separating membrane, which has advantage in terms of costs.

Pletcher et al., in J. Power Sources, 180, (2008), 621 have also worked on this type of battery and notably on the selection of additives to be added to the electrolyte with view to improving the quality of the lead deposit at the surface of the negative electrode. In particular, they were able to show that by using in the electrolyte a hexadecyltrimethylammonium cation C₁₆H₃₃(CH₃)₃N⁺, for example, at a concentration of 5 mM, it is possible to obtain a homogenous lead deposit with a substantially reduced roughness, in particular for high current densities (for example at 50 mA.cm⁻²). However, the presence in the electrolyte of fine black particles of lead dioxide is reported, which stem from the detachment of the lead dioxide deposit present at the surface of the positive electrode. Failing to be able to be filtered, these particles may be at the origin of the degradation of the quality of the lead at the negative electrode or even may generate short-circuits between the electrodes, if they accumulate in areas with a low flow of electrolyte.

Considering the drawbacks mentioned above, the authors of the present invention therefore set the goal of setting into place a novel type of lead battery operating with an electrolyte based on MSA and of a lead salt, this novel type notably allowing reduction in the deposition of lead dioxide particles in the electrolyte, or, in other words, improvement in the strength of the lead dioxide PbO₂ present on the positive electrode.

### DISCUSSION OF THE INVENTION

The authors of the present invention have surprisingly discovered that by adding a specific additive into the electrolyte of electrochemical cells of a lead battery operating with an electrolyte based on MSA, it is possible to surmount the drawbacks of the batteries of the prior art of this type.

Thus, the invention relates to an electrochemical lead battery comprising at least one electrochemical cell comprising a positive electrode comprising lead oxide PbO₂ and a negative electrode comprising lead metal separated by an electrolyte comprising methanesulfonic acid and at least one lead salt, characterized in that said electrolyte further comprises fluoride ions.

Before dealing with more detail with the discussion of the invention, we specify the following definitions.

By positive electrode is conventionally meant in the foregoing and in the following, the electrode which acts as a cathode (or, in other words is the center of a reduction), when the battery outputs current (i.e. when it is in a discharging process) and which acts as an anode (or, in other words which is a center of an oxidation), when the battery is in a charging process.

By negative electrode, is conventionally meant in the foregoing and in the following, the electrode which acts as an anode (or, in other words which is the center of an oxidation), when the accumulator outputs current (i.e. when it is in a discharging process) and which acts as a cathode (or, in other words which is a center of a reduction), when the battery is in a charging process.

Whether this is for the positive electrode or for the negative electrode, they may both be electrodes comprising a substrate, for example in an electron conducting material, at least one portion of which of its surface is covered with a layer of lead metal for the negative electrode and a layer of lead dioxide PbO₂ for the positive electrode.

More specifically, the aforementioned substrate may be a carbonaceous substrate, for example a substrate in a carbonaceous material selected from glassy carbon, graphite and mixtures thereof. This may also be any electron conducting carbonaceous material other than those explicitly listed above.

From a geometrical point of view, this substrate may appear as a planar plate or a plate having on at least one of its faces and, in particular, on the face intended to be in contact with the electrolyte, raised/recessed patterns.

As mentioned above, the electrolyte comprises methanesulfonic acid, at least one lead salt and fluoride ions.

Advantageously, the lead salt is lead methanesulfonate Pb(CH₃SO₃)₂, the solubility of this salt being particularly important in methanesulfonic acid and may be incorporated into this acid up to 2 M.

The electrolyte comprising lead methanesulfonate Pb(CH₃SO₃)₂ and methanesulfonic acid may be prepared:
by directly adding lead methanesulfonate into methanesulfonic acid; or
by dissolving lead oxide (PbO) or lead carbonate (PbCO₃) in methanesulfonic acid, a portion of this acid reacting with the lead oxide in order to form water and lead methanesulfonate or reacting with lead carbonate in order to form water, carbon dioxide and lead methanesulfonate.

The fluoride ions, as for them, are conventionally derived by adding to the electrolyte a fluoride salt, for example a fluoride salt of an alkaline element, such as sodium fluoride NaF.

The fluoride ions are advantageously present in a lower amount than that required for precipitation of Pb²⁺ ions in order to form PbF₂ and in an effective amount for avoiding detachment of the PbO₂ present at the surface of the positive electrode.

Indeed, the formation of PbF₂ is characterized by a white precipitate, which makes the electrolyte cloudy and, furthermore limits the amount of F⁻ ions present in the solution.

One skilled in the art may suitably select this amount, by making simple experimental tests.

For example, when the fluoride ions are derived from dissolution of NaF, starting with a solution comprising lead methanesulfonate Pb(CH₃SO₃)₂ in an amount of 1 M, the maximum amount of NaF, which may be added to said solution, satisfies, depending on the concentration of methanesulfonic acid, the following relationship:

[NaF]ₘₐₓ=0.33*[CH₃SO₃H]−0.01

One skilled in the art may also select a greater amount than the one used for avoiding precipitation of lead fluoride PbF₂. For low charge conditions of the battery, there will be a presence of a precipitate of lead sulfide, which precipitate will be redissolved for conditions of greater charge, by means of the acidity generated by the charging reactions of the battery at the positive electrode.

The batteries of the invention advantageously are batteries with a circulation of electrolyte, i.e. batteries for which the electrolyte is renewed by circulation via a reservoir containing said electrolyte.

As mentioned above and as shown in the particular embodiments which follow, it was shown that the fluoride ions in the specific electrolyte of the batteries of the invention contribute to improving the strength of the PbO₂ layer present at the surface of the positive electrode, which in other words means that this layer will tend to less disintegrate or not disintegrate at all in the form of particles in the presence of these fluoride ions as compared with the case when the electrolyte would not contain such ions.

Thus, the invention also relates to the use of fluoride ions in an electrolyte comprising methanesulfonic acid and at least one lead salt for improving the strength of the PbO₂ layer present at the surface of the positive electrode of an electrochemical lead battery.

For this use, the specific features of the battery mentioned above are also valid.

Other features and advantages of the invention will become apparent from the additional description which follows and which relates to particular embodiments.

Of course, this additional description is only given as an illustration of the invention and is by no means a limitation thereof.

### SHORT DESCRIPTION OF THE FIGURES

FIG. 1 illustrates a conventional cell of an electrochemical lead battery with circulation of electrolyte.

FIG. 2 is a graph illustrating the time dependent change of the potential E (expressed in volts relatively to Ag/Ag₂SO₄) of the working electrode versus time t (in h) for a current density of 10 mA.cm⁻² (curve a) respectively for the test with the electrolyte without any additive and a curve b) for the test with the electrolyte with additive) for example for which the operating conditions are mentioned below.

FIG. 3 is a graph illustrating the time dependent change in the charge Q (in C.cm⁻²) of the working electrode versus time t (in h) for a current density of 10 mA.cm⁻² (a curve a) for the test with the electrolyte without any additive and a curve b) for the test with the electrolyte with additive, respectively) for the example for which the operating conditions are mentioned below.

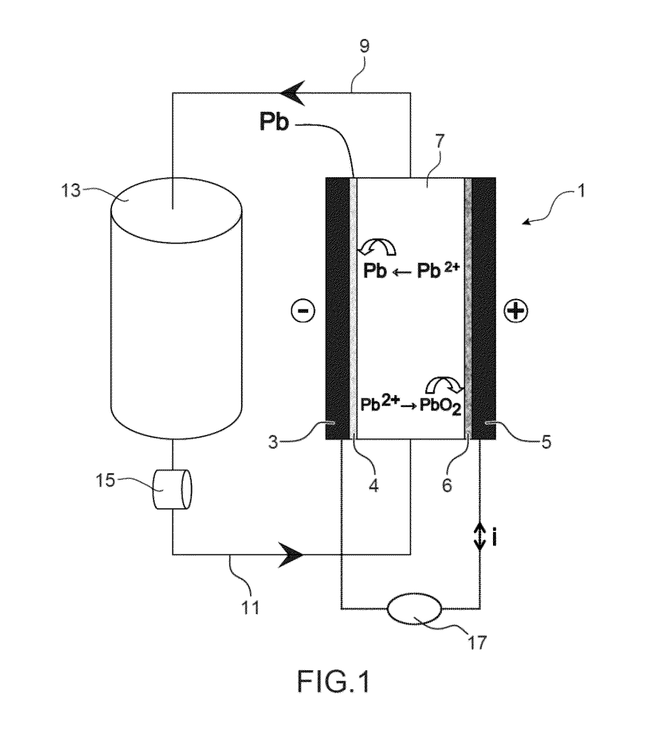

### DETAILED DISCUSSION OF PARTICULAR EMBODIMENTS

### Example 1

In this example, the effects of NaF on the cycling of the lead dioxide have been estimated, during a first test, as compared with a carbon electrode (more specifically an electrode with a glassy carbon disc with a diameter of 3 mm), playing the role of a working electrode in a conventional device with three electrodes, the counter electrode being in platinum and the reference electrode being in silver sulfate (Ag/Ag₂SO4, E=0.65 V vs. NHE). During cycling, a lead dioxide PbO₂ layer with a thickness of 60 μm is alternatively deposited and then re-dissolved on the disc of the positive electrode. This device is filled with about 30 ml of a solution of 1M Pb(CH₃SO₃)₂+0.2M CH₃SO₃H either containing or not NaF in an amount of 30 mM (described below as an additive). The solution is magnetically stirred.

Several galvanostatic cycles are applied to the working electrode, i.e. a positive alternating current is applied (with view to oxidation) and a negative alternating current is applied (with view to reduction). This device gives the possibility of mimicking the deposition/dissolution electrochemical reaction, which occurs at the positive electrode of a lead-MSA battery with circulation of electrolyte. For each cycle, the negative current for reducing PbO₂ is applied, until the potential suddenly drops, which marks the end of electrodissolution and the beginning of a new deposition/dissolution cycle.

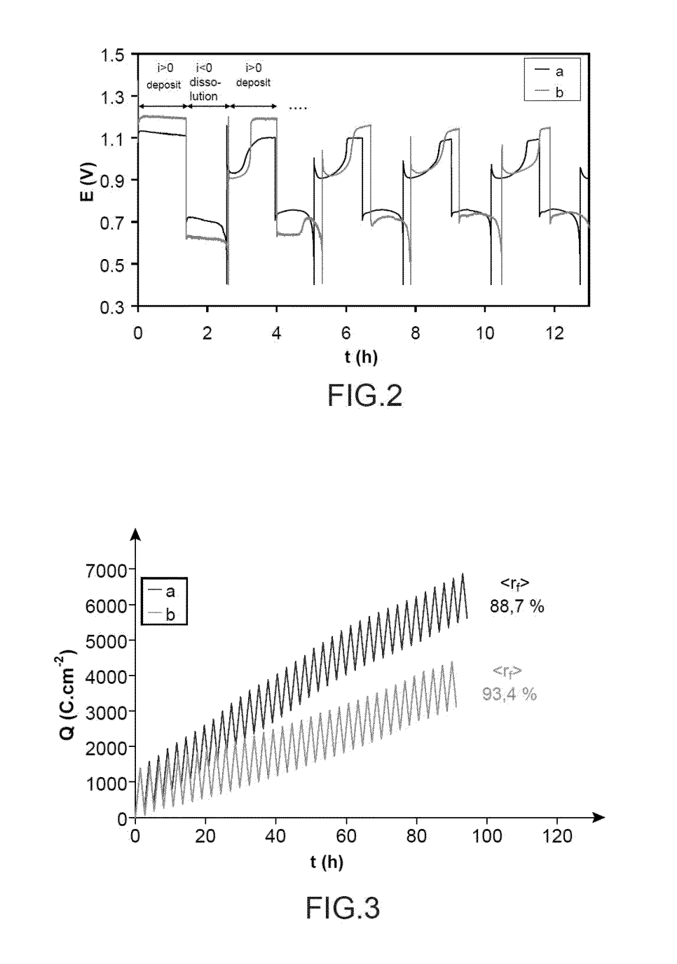

The potential responses of the working electrode during galvanostatic cycling of lead dioxide in the aforementioned electrolyte as well as in the same electrolyte without any additive are illustrated in FIG. 2 enclosed as an appendix, illustrating the time dependent change of the potential E (in volts relatively to Ag/Ag₂SO₄) of the working electrode versus time t (in h) for a current density of 10 mA.cm⁻² (a curve a) for the test with the electrolyte without any additive and a curve b) for the test with the electrolyte with additive, respectively).

It appears that sodium fluoride has little influence on the electrode potential. Slight additional over voltages appear in oxidation and in reduction as compared with the electrolyte without any additive but this effect tends to be resorbed after a few deposition/dissolution cycles. This demonstrates that the use of sodium fluoride in the battery electrolyte is quite possible.

Furthermore, while lead dioxide tends to be detached from the electrode as a black powder during the electrodeposition-electrodissolution cycling of lead dioxide in an MSA medium, the presence of NaF in the electrolyte has shown its capability of stabilizing lead dioxide on the electrode. More specifically, for the electrode with a glassy carbon disc, the amount of NaF required for having significant improvement in the strength of PbO₂ over many cycles (a few tens) is of about 30 mM. A solution to the problem of detachment of PbO₂ from the positive electrode of the lead-MSA battery with circulation may therefore be to add, in this context, NaF (30 mM) to the aforementioned specific electrolyte Pb(CH₃SO₃)₂+CH₃SO₃H.

A second test was conducted under similar conditions to that of the first test, except that the working electrode is now a graphite tube with a diameter of 3 mm and a surface area of more than 1 cm². The electrolyte, as such, satisfies the same specificities as the one of the first test, i.e. 1 M Pb(CH₃SO₃)₂+0.2 M CH₃SO₃H. It was ascertained that the amount of NaF required for having significant improvement in the strength of the PO₂ over many cycles (a few tens of cycles) should be greater than or equal to 150 mM.

A third test was conducted, consisting of measuring the accumulated amount of charges Q (in C.cm⁻²) during the cycling of PbO₂ versus time t (in h) under the same conditions relating to the electrolyte and to the device as those of the first test, except that the working electrode is now a graphite tube with a diameter of 3 mm and a length of 1 cm, said tube has a surface area of 1 cm². The results are transferred to FIG. 3 enclosed as an appendix with a curve a) for the test conducted with the electrolyte without any additive and a curve b) for the test conducted with the electrolyte with additive.

During oxidation, during the deposition of PbO₂, Q increases (the current is positive). Conversely, during reduction, during electrochemical dissolution of PbO₂, Q decreases, since the current is of opposite direction. The ratio between the amount of charge passed during the oxidative phase (Qₒₓ) over the amount of charge passed during the reducing phase (Q_{red}) gives the Faradic yield (r_{f}) of the process. The latter is less than 1 for several reasons:
on the one hand, the oxygen release reaction during the deposition of the PbO₂ consumes a portion of the charge Qₒₓ;
on the other hand the reduction of PbO₂ is incomplete, because of detachment of PbO₂ in the solution and of the residues remaining on the electrode and which can no longer be dissolved.

Thus, the accumulated charge never returns to zero but gradually increases during the cycles and this, all the most rapidly since the Faradic yield rf is low. The effect of NaF is clearly positive on the Faradic yield of the PbO₂ deposition/dissolution process. Without any additive, the Faradic yield is of about 89% (more specifically, 88.7%), while with the presence of NaF, it passes to more than 93% (more specifically, 93.4%).

As a conclusion, by transposing these results, and notably those of the second test, to a lead battery as such according to the invention with a positive electrode having a surface area greater than 1 cm², it is possible to use an electrolyte having a methanesulfonic acid concentration greater than 0.5 M with a concentration of NaF of 150 mM for allowing complete solubilization of the fluoride ions without precipitation of lead fluoride. This alternative has the advantage of having a large amount of fluoride ions in solution while avoiding the presence of solid PbF₂ particles in the electrolyte.

Alternatively, it is possible to use an electrolyte not very concentrated in acid (for example, an acid concentration of less than 0.2 M) in a cell in the discharge condition by adding a large amount of NaF (for example, 150 mM). There will then be a PbF₂ precipitation phenomenon for low charge conditions of the cell, for which the electrolyte is with a low acid concentration. However, the charge of the battery and the increase in the acidity, which is the consequence thereof, will allow re-solubilization of the PbF₂ (notably when [H^{+]} is greater than 0.5 M), therefore the increase in the concentration of F⁻ ions in the solution and removal of the solid suspended particles.

Taking into account the irrepressible increase in the acidity of the electrolyte, during the cycling of the Pb-MSA battery, related to the accumulation of lead and lead dioxide deposits at the electrodes, this alternative does not give the possibility of further overloading the electrolyte with acid.

1-9. (canceled)

10. An electrochemical lead battery comprising:
at least one electrochemical cell comprising
a positive electrode comprising lead oxide PbO₂; and
a negative electrode comprising lead metal separated by an electrolyte comprising methanesulfonic acid and at least one lead salt,
wherein said electrolyte further comprises fluoride ions.

11. The electrochemical lead battery according to claim 10,
wherein the positive electrode and the negative electrode are both electrodes comprising a substrate having at least one portion of its surface covered with a lead metal layer for the negative electrode and a lead oxide layer PbO₂ for the positive electrode.

12. The electrochemical lead battery according to claim 11, wherein the substrate is a carbonaceous substrate in a carbonaceous material selected from glassy carbon, graphite, and mixtures thereof.

13. The electrochemical lead battery according to claim 10, wherein the lead salt is lead methanesulfonate Pb(CH₃SO₃)₂.

14. The electrochemical lead battery according to claim 13, wherein the lead salt is incorporated into the methanesulfonic acid at a content ranging up to 2 M.

15. The electrochemical lead battery according to claim 10, wherein the fluoride ions are derived from a fluoride salt of an alkaline element.

16. The electrochemical lead battery according to claim 10, wherein the fluoride ions are derived from sodium fluoride.

17. The electrochemical lead battery according to claim 10, wherein said electrochemical lead battery is a battery with circulation of electrolyte.

18. A method of storing electrical energy, comprising:
providing fluoride ions in an electrolyte comprising methanesulfonic acid and at least one lead salt for improving strength of a PbO₂ layer present at a surface of a positive electrode of an electrochemical lead battery.
